(19) United States
(12) Patent Application Publication
(10) Pub. No.: US 2014/0131622 A1
(43) Pub. Date: May 15, 2014

(54) METHODS AND APPARATUS FOR COOLING SYNGAS FROM BIOMASS GASIFICATION

(71) Applicants: John D. Winter, Houston, TX (US); Benjamin F. Gardner, Superior, CO (US)

(72) Inventors: John D. Winter, Houston, TX (US); Benjamin F. Gardner, Superior, CO (US)

(73) Assignee: MAVERICK BIOFUELS, INC., Chapel Hill, NC (US)

(21) Appl. No.: 14/126,522

(22) PCT Filed: Jun. 15, 2012
(86) PCT No.: PCT/US2012/042559

§ 371 Date: Dec. 16, 2013

Related U.S. Application Data
(60) Provisional application No. 61/497,517, filed on Jun. 16, 2011.

(51) Int. Cl. C01B 3/02

(52) U.S. Cl. CPC C01B 3/02
USPC 252/373; 422/206; 422/643; 435/294.1

(57) ABSTRACT

Improved biomass-gasification methods and apparatus are described, for cooling hot syngas without relying on recycling cool syngas. In some variations, methods are provided for producing cooled syngas from a carbon-containing feedstock, comprising: gasifying the feedstock; feeding hot gas along with liquid water to a cooling device to accomplish humidification, thereby reducing the temperature (but not the enthalpy) of the hot gas; and then feeding the stream to a waste-heat recovery unit to recover energy and produce cool syngas. The invented methods and apparatus can prevent fouling of waste-heat recovery units. Additionally, these methods allow for effective management of tars produced during biomass gasification as well as improved water management.

### PRIORITY DATA

This international patent application claims the priority benefit of U.S. Provisional Patent App. No. 61/497,517, filed Jun. 16, 2011, the disclosure of which is hereby incorporated by reference herein.

### FIELD OF THE INVENTION

The present invention generally relates to the field of processes and apparatus for the conversion of carbonaceous materials to synthesis gas.

### BACKGROUND OF THE INVENTION

Synthesis gas (hereinafter referred to as syngas) is a mixture of hydrogen (H₂) and carbon monoxide (CO). Syngas can be produced, in principle, from virtually any material containing carbon. Carbonaceous materials commonly include fossil resources such as natural gas, petroleum, coal, and lignite; and renewable resources such as lignocellulosic biomass and various carbon-rich waste materials. It is preferable to utilize a renewable resource to produce syngas because of the rising economic, environmental, and social costs associated with fossil resources.

Syngas is a platform intermediate in the chemical and biorefining industries and has a vast number of uses. Syngas can be converted into alkanes, olefins, oxygenates, and alcohols. These chemicals can be blended into, or used directly as, diesel fuel, gasoline, and other liquid fuels. Syngas can be converted to liquid fuels, for example, by methanol synthesis, mixed-alcohol synthesis, Fischer-Tropsch chemistry, and syngas fermentation to ethanol. Syngas can also be directly combusted to produce heat and power.

All gasification processes generate syngas at elevated temperatures. For efficiency purposes, it is desirable to recover the sensible heat in the generated syngas as it is cooled for further processing. This waste-heat recovery device, commonly referred to as a waste-heat boiler, is a major cost component of biomass gasification processes.

The reliability and cost of the waste-heat boiler, as well as the quantity and temperature level of heat recovered, are keys to the economic performance of biomass gasification facilities. This is a particularly complicated issue for biomass gasification, which typically includes both unconverted carbon and tars formed in the process, as well as carbon formed via the Boudouard reaction (2 CO→C+CO₂) as the gas is cooled. All of these constituents can create fouling or plugging in the waste-heat boiler.

It is common practice in the art to recycle cooled syngas from downstream of the waste-heat boiler (either upstream or downstream of particulate removal from the cooled gas) to a point upstream of the waste-heat boiler. Such syngas recycling is carried out to reduce the cost or fouling of the waste-heat boiler without losing total energy content of the syngas; although the temperature and hence exergy of the syngas is degraded, the enthalpy is not. This direct syngas quench step is typically carried out to deliver a quench exit (and waste-heat boiler inlet) temperature between about 1200° F. and 1600° F.

Recycling cooled syngas, however, is exceptionally costly. Capital costs are high due to the size of the equipment and the type of shaft seals needed to isolate flammable syngas from the atmosphere. Operating costs are high due to the high-quality energy needed to drive the recycle device (commonly electrical power) to increase the pressure of the gas sufficiently to recycle the gas. Energy consumption is particularly high in the case of low-pressure (<5 bar) gasification processes in which the pressure difference to be generated by the recycle device is an appreciable fraction of the gas absolute pressure.

In view of the foregoing economic considerations, what are needed are new or improved gasification methods and apparatus for reducing or preventing fouling of waste-heat boilers, without relying on recycling cooled syngas. Preferred methods should include effective management of tars produced during biomass gasification.

### SUMMARY OF THE INVENTION

In some variations, this invention provides a method of producing cooled syngas from a carbon-containing feedstock, the method comprising:
(a) introducing a carbon-containing feedstock and an oxidant to a reactor under suitable conditions for gasifying the carbon-containing feedstock, thereby generating a first vapor stream comprising hot syngas;
(b) feeding at least a portion of the first vapor stream to a cooling device;
(c) introducing a liquid to the cooling device, whereby a portion of heat contained in the hot syngas is effective to vaporize the liquid and cool the first vapor stream to generate a second vapor stream; and
(d) feeding the second vapor stream to a waste-heat recovery unit to recover at least some thermal energy associated with the second vapor stream, thereby producing cool syngas.

In some embodiments, the carbon-containing feedstock includes biomass, such as wood chips. The invention is by no means limited to utilization of biomass.

The liquid introduced to the cooling device may contain water, or may consist essentially of water. The water may be process condensate, in certain embodiments. The process condensate may comprise tars derived from the carbon-containing feedstock. At least a portion of the tars are removed in some embodiments.

The cooling device may be selected from the group consisting of a static mixer, a heat exchanger, a vessel, a column, a ceramic membrane, a section of pipe, and any number or combination thereof.

In some embodiments, the cooling device is configured to introduce the liquid in a plurality of locations. In some embodiments, the cooling device is configured to reduce the average droplet size of the liquid prior to introduction into the cooling device. The liquid may be injected into the cooling device through a means for droplet-size reduction selected from the group consisting of a screen, a ceramic filter, a molecular sieve, and any number or combination thereof. Optionally, the liquid is injected into the cooling device through a nozzle.

When water is used as the cooling liquid, various water contents in the syngas are possible. In some embodiments, the molar H₂O/CO ratio of the liquid introduced to the cooling device divided by CO in the first vapor stream is from about 0.01 to about 5, such as about 0.1 to about 2, or about 0.5 to about 1.5.

Preferably, the dew point of the second vapor stream is less than the temperature of the second vapor stream, such as at least 100° F., 200° F., 300° F., 400° F., or 500° F. below the temperature of the second vapor stream. In some embodiments, during step (c) the second vapor stream is cooled to a temperature from about 1000° F. to about 1800° F., such as about 1200-1600° F. or about 1300-1500° F.

Generally a conduit (or similar means) is used to convey the second vapor stream from the cooling device to the waste-heat recovery unit. During step (d), preferably no liquid droplets reach the wall of the conduit.

In some embodiments, the method further includes capturing and removing tars and/or particulate matter between steps (c) and (d), or after step (d), or both between steps (c)-(d) and after step (d).

Step (d) may include cooling the second vapor stream to below its dew point. In some embodiments, the temperature of the cool syngas is from 250° F. to about 1500° F., such as about 500-1000° F.

Another variation of the invention provides a method of producing cooled syngas from a carbon-containing feedstock, the method comprising:
(a) introducing a carbon-containing feedstock and an oxidant to a reactor under suitable conditions for gasifying the carbon-containing feedstock, thereby generating a first vapor stream comprising hot syngas;
(b) feeding at least a portion of the first vapor stream to a cooling device;
(c) introducing a liquid to the cooling device, whereby a portion of heat contained in the hot syngas is effective to vaporize the liquid and cool the first vapor stream to generate a second vapor stream; and
(d) feeding the second vapor stream to a waste-heat recovery unit to recover at least some thermal energy associated with the second vapor stream, thereby producing cool syngas,
wherein the method does not include syngas cooling by gas recycle.

Another variation of the invention provides a method of producing cooled syngas from a carbon-containing feedstock, the method comprising:
(a) means for gasifying a carbon-containing feedstock to generate a first vapor stream comprising hot syngas;
(b) means for feeding at least a portion of the first vapor stream to a means for cooling;
(c) means for introducing a liquid to the means for cooling, whereby a portion of heat contained in the hot syngas is effective to vaporize the liquid and cool the first vapor stream to generate a second vapor stream; and
(d) means for feeding the second vapor stream to means for waste-heat recovery of at least some thermal energy associated with the second vapor stream, thereby producing cool syngas.

The methods of the invention may further include converting the cool syngas to a product. The product may be selected from the group consisting of alcohols, alkanes, olefins, aldehydes, ethers, acids, and hydrogen. In some embodiments, the produce is, or includes, an alcohol such as ethanol.

The present invention also includes an apparatus configured to carry out any of the described methods. For example, some embodiments relate to an apparatus for producing cool syngas from a carbon-containing feedstock, the apparatus comprising:
(a) a reactor for gasifying a carbon-containing feedstock, to generate a first vapor stream comprising hot syngas;
(b) a cooling device for cooling at least a portion of the first vapor stream;
(c) an inlet to the cooling device for vaporizing a liquid and cooling the first vapor stream to generate a second vapor stream; and
(d) a waste-heat recovery unit for recovering thermal energy associated with the second vapor stream, to produce cool syngas.

In some apparatus embodiments, the cooling device is selected from the group consisting of a static mixer, a heat exchanger, a vessel, a column, a ceramic membrane, a section of pipe, and any number or combination thereof. The cooling device may be configured to introduce the liquid in a plurality of locations.

Additionally, the cooling device may be configured to reduce the average droplet size of the liquid. In some embodiments, the apparatus includes a nozzle in fluid communication with the cooling device. In various embodiments, the apparatus includes a means for droplet-size reduction, in fluid communication with the cooling device, selected from the group consisting of a screen, a ceramic filter, a molecular sieve, and any number or combination thereof.

Other variations of the invention provide an apparatus for producing cool syngas from a biomass, the apparatus comprising:
(a) a gasifier for gasifying biomass, to generate a first vapor stream comprising hot syngas;
(b) a cooling device for receiving at least a portion of the first vapor stream and a stream containing water;
(c) an inlet to the cooling device for vaporizing substantially all of the water and cooling the first vapor stream to generate a second vapor stream; and
(d) a waste-heat boiler for recovering thermal energy associated with the second vapor stream, to produce cool syngas.

The apparatus may further comprise a syngas-conversion unit for catalytically converting at least some of the cool syngas to one or more alkanes, alcohols, olefins, aldehydes, ethers, or acids.

Alternatively, or additionally, the apparatus may include a syngas fermentor for biologically converting at least some of the cool syngas to ethanol or another syngas-fermentation product.

### BRIEF DESCRIPTION OF THE FIGURES

FIG. 1 depicts an exemplary process configuration according to some embodiments of the invention.

FIG. 2 depicts an exemplary process configuration according to some embodiments, wherein water is injected at several locations into the cooling device.

These and other embodiments, features, and advantages of the present invention will become more apparent to those skilled in the art when taken with reference to the following detailed description of the invention in conjunction with the accompanying drawings.

### DETAILED DESCRIPTION OF EMBODIMENTS OF THE INVENTION

This description will enable one skilled in the art to make and use the invention, and it describes several embodiments, adaptations, variations, alternatives, and uses of the invention, including what is presently believed to be the best mode of carrying out the invention.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing parameters, conditions, concentrations, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

Some variations of the present invention are premised, at least in part, on the realization that instead of recycling cold syngas, liquid water can be injected in sufficient amount to lower the syngas temperature via evaporation of water. Although the temperature of the gas is reduced, the sensible heat of the gas (comprising syngas and vaporized water) can be preserved. Essentially, some of the sensible heat contained in the syngas transfers to the water to accomplish a phase change from liquid to vapor. The resulting water vapor substantially includes the sensible heat transferred from the syngas. Except for heat losses, the sensible heat available for recovery from the gas stream in the subsequent waste-heat recovery device is substantially preserved.

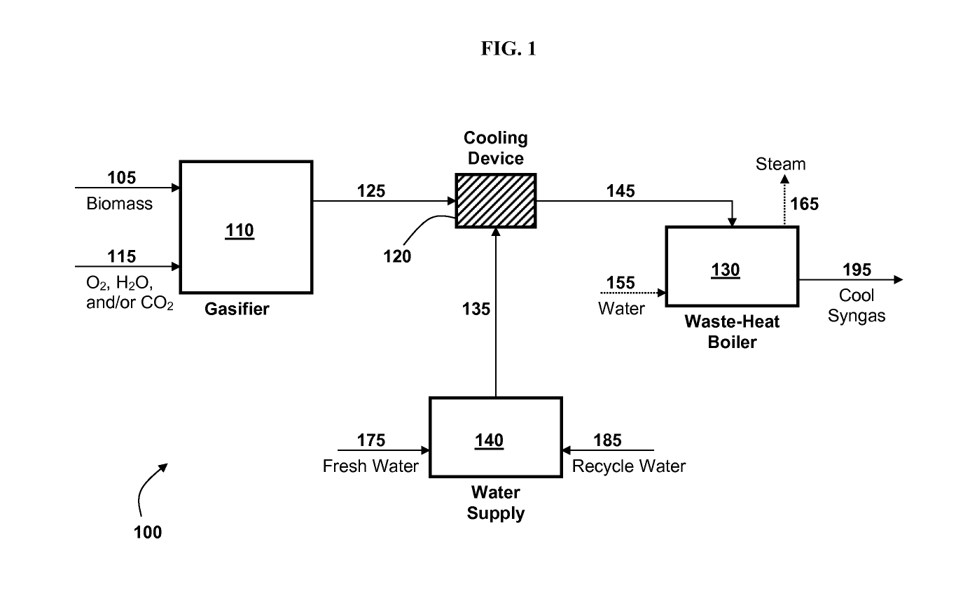

FIG. 1 shows a block-flow diagram of some method and apparatus variations of the invention. The overall process configuration 100 in FIG. 1 includes a biomass gasifier 110, a cooling device 120, a waste-heat boiler 130, and a water supply 140. A gas stream 125 from the gasifier 120 is introduced to the cooling device 120, along with a water-containing stream 135. The cooled gas stream 145 is then fed to a waste-heat boiler 130 to further cool the gas, thereby producing cooled syngas 195. Here, “cooled syngas” (product stream 195) contains at least CO and H₂ and may also include one or more of CO₂, H₂O, CH₄, H₂S, inerts such as N₂, and higher hydrocarbons such as tars.

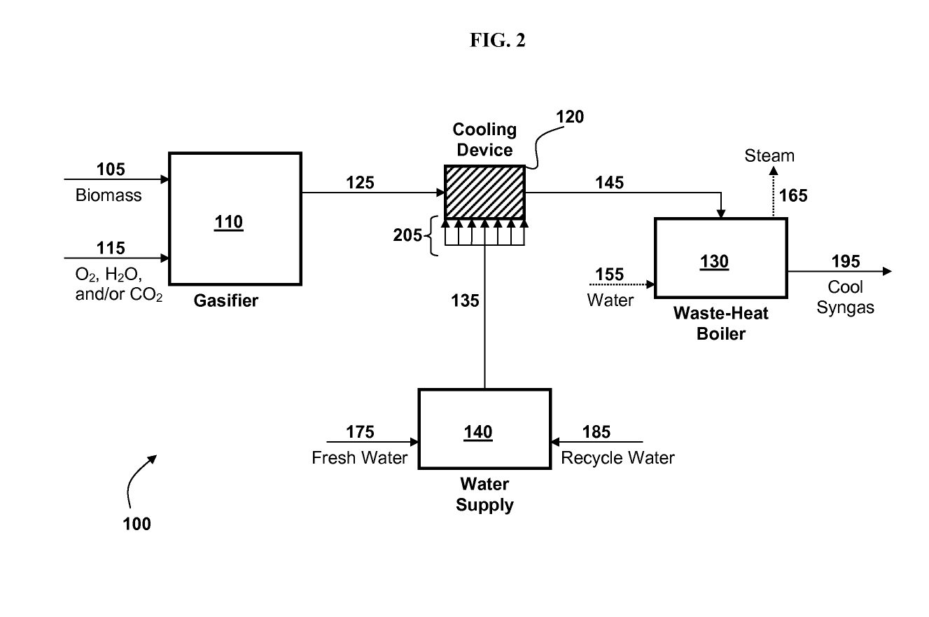

A water-containing stream 135 from the water supply 140 feeds into the cooling device 120 at one or more locations within and/or upstream of the cooling device 120. FIG. 1 shows a single point of entry of water into the cooling device 120, but the present invention is by no means limited to this embodiment. For example, in FIG. 2, stream 135 is introduced into the cooling device at a plurality of locations 205 for injection into the cooling device 120. The number of locations 205 is FIG. 2 is merely exemplary and may vary from 1 to 10 or more, in various embodiments.

In principle, stream 135 can include liquid, gas, and solid phases (e.g., impurities), provided at least some liquid can vaporize in the cooling device 120. In preferred embodiments, stream 135 comprises water, or consists essentially of water.

The water supply 140 can take any suitable form or configuration. The water supply 140 may be a physical vessel or tank, or several tanks The water supply 140 may include tanks that operate in continuous or batch mode. In some embodiments, the water supply does not necessarily include physical tanks but rather a control scheme to route one or more water sources to the cooling device 120. For example, water sources may include direct piping from process condensate, other recycle water, wastewater, make-up water, boiler feed water, city water, and so on. External to water supply 140 or within a unit for containing the water supply 140, water can be cleaned, purified, treated, ionized, distilled, and the like. Some embodiments of the water supply 140 include such direct piping of e.g. process condensate water into the cooling device 120 as well as batch storage for supplemental water upon demand. When several water sources are used, various volume ratios of water sources are possible.

In some embodiments, a portion or all of the water for the water supply 140 is process condensate recovered from the waste-heat boiler(s), or downstream thereof. These embodiments may be advantageous because they can provide for management of where and when tar condensation occurs and when water condensation occurs. These embodiments can allow for recovery of tars from water condensate separately from downstream water scrubbers used for particulate control.

Preferably, to remain above the saturation temperature of water for the process pressure, only enough water to cool the gas is injected (little or no excess water). The dew point of the gas 145 exiting the cooling device 120 should be below the exit temperature. The dew point of the gas 145 may be, in some embodiments, at least 100° F., 200° F., 300° F., 400° F., 500° F. or more degrees below the temperature of stream 145.

In some embodiments, no liquid water exits the cooling device 120. To ensure that no liquid water exits, i.e. that all liquid water injected is effectively vaporized within the cooling device, the amount of water and gas and the temperature of water and gas should be considered in thermodynamic calculations. The temperature of hot gas stream 125 may be, for example, about 1000-2500° F., such as about 1500-2000° F. The temperature of water-containing stream 135 may be, for example, about 40-200° F., such as about 50-100° F. The temperature of gas stream 145 may be, for example, in the range of 500-2000° F., 1000-1800° F., 1200-1600° F., or about 1400° F.

The amount of hot gas 125 will of course vary with the scale of the process 100 and the yields realized in the gasifier 110. The amount of water to introduce to the cooling device 120 can optionally be calculated with a “humidification ratio” H₂O/CO, which is the molar ratio of added water to carbon monoxide in the incoming syngas. The humidification ratio does not include water that may already be present in stream 125 entering the cooling device 120. A wide range of humidification ratios is possible, including about 0.1 or less (such as 0.05) to about 2 or more (such as 3). A person of ordinary skill in the art can readily perform engineering calculations or simulations to assess the thermal impact of various humidification ratios as a function of temperatures and amounts of streams 125 and 135.

Thermodynamics alone, however, are not necessarily sufficient to design a particular gas-cooling process. Mass and heat transport are also important because water droplets injected into the cooling device 120 must consume heat from the hot gas, and vaporize, on a timescale consistent with the residence time of the cooling device 120. The water molecules are essentially heat sinks for hot gas molecules; heat and mass transfer are linked. It is preferred that the cooling device 120 is suitably designed for good mixing to avoid both hot spots and cold spots (which could create new droplets) in stream 145. Again, a skilled artisan can use engineering principles of mass and heat exchangers to design cooling devices, with calculation of heat-transfer surface area, heat-transfer coefficients, and mass-transfer coefficients, for example.

Specifically, by controlling the injection path and placement, as well as droplet size, water can be injected into the hot syngas such that no liquid stream leaves the cooling device 120. In preferred embodiments, no liquid droplets reach the wall of the syngas conduit, i.e. stream 145.

The cooling device 120 may include any gas-liquid contacting device or quench system known in the art. For example, the cooling device 120 may be a static mixer, a heat exchanger, a vessel, a column, a series of ceramic membranes, or a section of pipe (e.g., serpentine pipes to enhance mixing). In some embodiments, a large contact surface between a gas and a liquid is used.

In some embodiments, the hot gas may be sprayed into a water quench system. In another example, the hot gas may be passed with concurrent or countercurrent flow of water into a scrubbing tower containing various forms of packing, baffles, bubble cap trays, sieve trays, and the like. In another example, the hot gas may be subjected to various washers such as Venturi washers, vortex washers, and rotary washers, all of which are well known in the art.

To enhance heat and mass transfer, water may be introduced into the cooling device 120 using a nozzle, which is generally a mechanical device designed to control the direction or characteristics of a fluid flow as it enters an enclosed chamber or pipe via an orifice. Nozzles are capable of reducing the water droplet size to generate a fine spray of the water-containing stream 135. Nozzles may be selected from atomizer nozzles (similar to fuel injectors), swirl nozzles which inject the liquid tangentially, etc.

Various injection schemes are possible. Water may be injected at a single location (such as shown in FIG. 1) or in a plurality of locations (such as shown in FIG. 2). The plurality of locations may be anywhere on a surface of, or within, the cooling device 120. Alternatively, or additionally, water may be injected upstream of the cooling device 120, such as into stream 125. In some embodiments, a means for droplet-size reduction is included, such as screens, ceramic filters, or molecular sieves capable of forming small water droplets.

The type of injection at one or more injection locations may vary, including for example continuous injection, where water flows at all times from the injector, at a variable rate; pulsed injection, where water is provided during short pulses of varying duration, with a constant rate of flow during each pulse; central port injection, where tubes with valves from a central injector spray water at each intake port; and direct injection, where water is sent through tubing to the injectors which inject it into the cooling device 120. In some embodiments, injection is mechanical, requiring no electricity to operate. Injectors can be fed by a constant-pressure water pump, such as in stream 135.

Various control strategies may be implemented to vary the amount of water introduced to the cooling device. For example, the water content or any other species concentrations (such as CO or H₂) could be monitored at one or more of streams 125, 145, 195, or an internal stream or sampling point within the cooling device 120 (not shown). Temperatures and pressures throughout the process may be monitored and used to adjust the water input. The energy content of stream 145, as realized in the waste-heat boiler 130, may be utilized as feedback to adjust stream 135. The pressure of the steam generated in the waste-heat boiler 130 also may be used to control the amount of humidification.

Thermal energy of stream 145 is recovered in one or more waste-heat recovery exchangers 130, shown in FIGS. 1 and 2 as waste-heat boilers. The waste-heat boiler can be designed and/or operated to produce steam or hot water by heating water. The waste-heat boiler can also be designed and/or operated to heat (directly or indirectly) oil, gas, or any other material. Typically, steam is produced by the waste-heat boilers. This steam can be used to drive machinery directly, or to generate power via a turbo-alternator. Alternatively, or additionally, the steam can provide heat for process services, such as biomass drying or alcohol distillation. Steam may also be injected directly into the gasifier 110. In addition, heat available in the waste-heat boilers may be used to heat other process streams, including gas streams that are fed directly, or used to heat indirectly, any unit operation within the process.

The temperature of gas stream 145 entering the waste-heat boiler 130 may be, for example, in the range of 500-2000° F. The temperature of cool syngas 195 will be lower than the temperature of stream 145 and may be, for example, in the range of 250-1500° F. or 500-1000° F., in various embodiments. The waste-heat boiler may include cooling to below the dew point of the gas.

Tars entering the cooling device 120 in stream 125 preferably remain in the vapor phase, but it is recognized that at least a portion of the tars may condense, depending on the amount of cooling. These condensed tars will generally be carried (entrained) in stream 145 to the waste-heat boiler 130.

When the water source includes process condensate having tars therein, the present invention allows for enhanced management of tars. Tars in the water, feeding into the cooling device 120, may enter the gas stream and allow removal at a location downstream, separately from any water scrubbers used for particulate control of the waste-heat boiler 130.

Salts from the evaporated water (from the waste-heat boiler 130) may be captured with the rest of the syngas particulate matter (e.g., finely divided unreacted carbonaceous materials and other mineral fines). The salts and particulates may be removed in any place downstream, periodically removed in a water wash, and/or periodically removed from a physical accumulation space.

The gasifier 110 can be, but is not limited to, a fluidized bed. Any known gasifier can be employed. In variations, the gasifier type may be entrained-flow slagging, entrained flow non-slagging, transport, bubbling fluidized bed, circulating fluidized bed, or fixed bed. Some embodiments employ gasification catalysts.

“Gasification” and “gasify” generally refer to the reactive generation of a mixture of at least CO, CO₂, and H₂, using oxygen, steam, and/or carbon dioxide as the reactant(s). Any known gasifier can be employed. In variations, the gasifier 110 type is entrained-flow slagging, entrained flow non-slagging, transport, bubbling fluidized bed, circulating fluidized bed, and fixed bed.

If gasification is incomplete, a solid stream can be generated, containing some of the carbon initially in the feed material. The solid stream produced from the gasification step can include ash, metals, unreacted char, and unreactive refractory tars and polymeric species. Generally speaking, feedstocks such as biomass contain non-volatile species, including silica and various metals, which are not readily released during pyrolysis, torrefaction, or gasification. It is of course possible to utilize ash-free feedstocks, in which case there should not be substantial quantities of ash in the solid stream from the gasification step.

When a fluidized-bed reactor is used, the feedstock can be introduced into a bed of hot sand fluidized by a gas, such as recycled syngas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat is usually provided by heat-exchanger tubes through which hot combustion gas flows.

Circulating fluidized-bed reactors can be employed, wherein gas, sand, and feedstock move together. Exemplary transport gases include recirculated product gases and combustion gases. High heat-transfer rates from the sand ensure rapid heating of the feedstock, and ablation is expected to be stronger than with regular fluidized beds. A separator can be employed to separate the product gases from the sand and char particles. The sand particles can be reheated in a fluidized burner vessel and recycled to the reactor.

In some embodiments in which a countercurrent fixed-bed reactor is used, the reactor consists of a fixed bed of a feedstock through which a gasification agent (such as steam, oxygen, and/or air) flows in countercurrent configuration. The ash is either removed dry or as a slag.

In some embodiments in which a cocurrent fixed-bed reactor is used, the reactor is similar to the countercurrent type, but the gasification agent gas flows in cocurrent configuration with the feedstock. Heat is added to the upper part of the bed, either by combusting small amounts of the feedstock or from external heat sources. The produced gas leaves the reactor at a high temperature, and much of this heat is transferred to the gasification agent added in the top of the bed, resulting in good energy efficiency. Since tars pass through a hot bed of char in this configuration, tar levels are expected to be lower than when using the countercurrent type.

In some embodiments in which a fluidized-bed reactor is used, the feedstock is fluidized in oxygen and steam or air. The ash is removed dry or as heavy agglomerates that defluidize. Recycle or subsequent combustion of solids can be used to increase conversion. Fluidized-bed reactors are useful for feedstocks that form highly corrosive ash that would damage the walls of slagging reactors.

In some embodiments in which an entrained-flow reactor is used, char is gasified with oxygen or air in cocurrent flow. The gasification reactions take place in a dense cloud of very fine particles. High temperatures can be employed, thereby providing for low quantities of tar and methane in the product gas.

Entrained-flow reactors remove the major part of the ash as a slag, as the operating temperature is typically well above the ash fusion temperature. A smaller fraction of the ash is produced either as a very fine dry fly ash or as a fly-ash slurry. Some feedstocks, in particular certain types of biomass, can form slag that is corrosive. Certain entrained-bed reactors have an inner water- or steam-cooled wall covered with partially solidified slag.

In general, solid, liquid, and gas streams produced or existing within the process can be independently passed to subsequent steps or removed/purged from the process at any point. Many recycle options will be recognized by a person of ordinary skill in the art. As an example, a portion of water in stream 135, or another stream from water supply 140, may be routed to the gasifier 110 when it is desired to introduce water in gasification.

The methods and apparatus of the invention can accommodate a wide range of feedstocks of various types, sizes, and moisture contents. “Biomass,” for the purposes of the present invention, is any material not derived from fossil resources and comprising at least carbon, hydrogen, and oxygen. Biomass includes, for example, plant and plant-derived material, vegetation, agricultural waste, forestry waste, wood waste, paper waste, animal-derived waste, poultry-derived waste, and municipal solid waste. Other exemplary feedstocks include cellulose, hydrocarbons, carbohydrates or derivates thereof, and charcoal.

In various embodiments of the invention utilizing biomass, the biomass feedstock can include one or more materials selected from: timber harvesting residues, softwood chips, hardwood chips, tree branches, tree stumps, leaves, bark, sawdust, off-spec paper pulp, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, plastic, and cloth. A person of ordinary skill in the art will readily appreciate that the feedstock options are virtually unlimited.

The present invention can also be used for carbon-containing feedstocks other than biomass, such as a fossil fuel (e.g., coal or petroleum coke), or any mixtures of biomass and fossil fuels. For the avoidance of doubt, any method, apparatus, or system described herein can be used with any carbonaceous feedstock.

Selection of a particular feedstock or feedstocks is not regarded as technically critical, but is carried out in a manner that tends to favor an economical process. Typically, regardless of the feedstocks chosen, there can be (in some embodiments) screening to remove undesirable materials. The feedstock can optionally be dried prior to processing. Optionally, particle-size reduction can be employed prior to conversion of the feedstock to syngas. Particle size is not, however, regarded as critical to the invention.

The cool syngas 195 can be converted to one or more commercially useful products. In some variations, the syngas is filtered, purified, or otherwise conditioned prior to being converted to another product. For example, syngas may be purified wherein BTEX, sulfur compounds, nitrogen, metals, and/or other impurities are optionally removed from the syngas.

The syngas produced as described according to the present invention can be utilized in a number of ways. Syngas can generally be chemically converted and/or purified into hydrogen, carbon monoxide, methane, graphite, olefins (such as ethylene), oxygenates (such as dimethyl ether), alcohols (such as methanol and ethanol), paraffins, and other hydrocarbons. Syngas can be converted into linear or branched C₅-C₁₅ hydrocarbons, diesel fuel, gasoline, waxes, or olefins by Fischer-Tropsch chemistry; methanol, ethanol, and mixed alcohols by a variety of catalysts; isobutane by isosynthesis; ammonia by hydrogen production followed by the Haber process; aldehydes and alcohols by oxosynthesis; and many derivatives of methanol including dimethyl ether, acetic acid, ethylene, propylene, and formaldehyde by various processes.

In some embodiments, the syngas is converted to methanol using known methanol catalysts. In some embodiments, the syngas is converted to fuel components using known Fischer-Tropsch catalysts. In certain embodiments, the syngas is converted to mixed alcohols, particularly ethanol. Syngas can be selectively converted to ethanol by means of a chemical catalyst, such as described in U.S. patent application Ser. No. 12/166,203, entitled “METHODS AND APPARATUS FOR PRODUCING ALCOHOLS FROM SYNGAS,” filed Jul. 1, 2008, which is hereby incorporated herein by reference. As is known in the art, syngas can also be fermented to ethanol using microorganisms.

The syngas produced according to the methods and apparatus of the invention can also be converted to energy. Syngas-based energy-conversion devices include a solid-oxide fuel cell, Stirling engine, micro-turbine, internal combustion engine, thermo-electric generator, scroll expander, gas burner, or thermo-photovoltaic device.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

As an example of a variation that is within the inventive scope, the liquid that is vaporized in the cooling device 120 and cools the hot syngas need not actually be water. Theoretically, the liquid could be any liquid such as an ether, an alcohol (e.g., methanol or mixed alcohols), or a hydrocarbon. Economics will dictate that water normally is the humidification agent for cooling, but the scope of the invention is not limited to the use of water.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

1. A method of producing cooled syngas from a carbon-containing feedstock, said method comprising:
(a) introducing a carbon-containing feedstock and an oxidant to a reactor under suitable conditions for gasifying said carbon-containing feedstock, thereby generating a first vapor stream comprising hot syngas;
(b) feeding at least a portion of said first vapor stream to a cooling device;
(c) introducing a liquid to said cooling device, whereby a portion of heat contained in said hot syngas is effective to vaporize said liquid and cool said first vapor stream to generate a second vapor stream; and
(d) feeding said second vapor stream to a waste-heat recovery unit to recover at least some thermal energy associated with said second vapor stream, thereby producing cool syngas.

2. The method of claim 1, wherein said carbon-containing feedstock includes biomass.

3. (canceled)

4. The method of claim 1, wherein said liquid comprises water.

5. (canceled)

6. The method of claim 4, wherein said water is process condensate.

7. The method of claim 6, wherein said process condensate comprises tars derived from said carbon-containing feedstock.

8. The method of claim 7, further comprising removing at least a portion of said tars.

9. The method of claim 1, wherein said cooling device is selected from the group consisting of a static mixer, a heat exchanger, a vessel, a column, a ceramic membrane, a section of pipe, and any number or combination thereof.

10-13. (canceled)

14. The method of claim 1, wherein the molar H₂O/CO ratio of said liquid introduced to said cooling device divided by CO in said first vapor stream is from about 0.01 to about 5.

15-16. (canceled)

17. The method of claim 1, wherein the dew point of said second vapor stream is less than the temperature of said second vapor stream.

18-19. (canceled)

20. The method of claim 1, wherein during step (c), said second vapor stream is cooled to a temperature from about 1000° F. to about 1800° F.

21-22. (canceled)

23. The method of claim 1, wherein a conduit is used to convey said second vapor stream from said cooling device to said waste-heat recovery unit, and wherein during step (d), no liquid droplets reach the wall of said conduit.

24. The method of claim 1, further comprising capturing and removing tars and/or particulate matter between steps (c) and (d).

25. The method of claim 1, further comprising capturing and removing tars and/or particulate matter after step (d).

26. The method of claim 1, wherein step (d) includes cooling said second vapor stream to below its dew point.

27-28. (canceled)

29. A method of producing cooled syngas from a carbon-containing feedstock, said method comprising:
(a) introducing a carbon-containing feedstock and an oxidant to a reactor under suitable conditions for gasifying said carbon-containing feedstock, thereby generating a first vapor stream comprising hot syngas;
(b) feeding at least a portion of said first vapor stream to a cooling device;
(c) introducing a liquid to said cooling device, whereby a portion of heat contained in said hot syngas is effective to vaporize said liquid and cool said first vapor stream to generate a second vapor stream; and
(d) feeding said second vapor stream to a waste-heat recovery unit to recover at least some thermal energy associated with said second vapor stream, thereby producing cool syngas,
wherein said method does not include syngas cooling by gas recycle.

30-35. (canceled)

36. An apparatus for producing cool syngas from a carbon-containing feedstock, said apparatus comprising:
(a) a reactor for gasifying a carbon-containing feedstock, to generate a first vapor stream comprising hot syngas;
(b) a cooling device for cooling at least a portion of said first vapor stream;
(c) an inlet to said cooling device for vaporizing a liquid and cooling said first vapor stream to generate a second vapor stream; and
(d) a waste-heat recovery unit for recovering thermal energy associated with said second vapor stream, to produce cool syngas.

37. The apparatus of claim 36, wherein said cooling device is selected from the group consisting of a static mixer, a heat exchanger, a vessel, a column, a ceramic membrane, a section of pipe, and any number or combination thereof.

38-39. (canceled)

40. The apparatus of claim 36, further comprising a nozzle in fluid communication with said cooling device.

41. The apparatus of claim 36, further comprising a means for droplet-size reduction, in fluid communication with said cooling device, selected from the group consisting of a screen, a ceramic filter, a molecular sieve, and any number or combination thereof.

42. The apparatus of claim 1, wherein:
the cooling device is capable of receiving at least a portion of said first vapor stream and a stream containing water;
the inlet is capable of vaporizing substantially all of said water and cooling said first vapor stream to generate a second vapor stream; and
the waste-heat recovery unit is a waste-heat boiler.

43. (canceled)

44. The apparatus of claim 36, further comprising a syngas-conversion unit for catalytically converting at least some of said cool syngas to one or more alcohol, alkane, olefin, aldehyde, ether, or acids.

45. The apparatus of claim 36, further comprising a syngas fermentor for biologically converting at least some of said cool syngas to ethanol.
